(19) United States
(12) Patent Application Publication
(10) Pub. No.: US 2016/0246781 A1
(43) Pub. Date: Aug. 25, 2016

(54) MEDICAL INTERACTION SYSTEMS AND METHODS

(71) Applicant: Gary Cabot, Honolulu, HI (US)

(72) Inventor: Gary Cabot, Honolulu, HI (US)

(21) Appl. No.: 15/043,528

(22) Filed: Feb. 13, 2016

Related U.S. Application Data
(60) Provisional application No. 62/118,036, filed on Feb. 19, 2015.

(51) Int. Cl. G06F 17/28; G06F 17/27

(52) U.S. Cl. CPC G06F 17/289; G06F 17/275

(57) ABSTRACT

A medical interaction system which in some embodiments, may include: a speaker for providing audio output to the users; a graphical user interface for displaying visual information output to and receiving user input from the users; and a processor in communication with the speaker and the graphical interface, in which the processor is configured to identify a first language selected by the first user with the graphical user interface, identify a second language selected by the second user with the graphical user interface, receive first language input from the first user, interpret the first language input into a second language output, provide the second language output to the second user, receive second language input from the second user, determine second user consent to the second language output, interpret the second language input into first language output, and provide the first language output to the first user.

### CROSS REFERENCE TO RELATED APPLICATIONS

This application claims priority to and the benefit of the filing date of U.S. Provisional Application No. 62/118,036, filed on Feb. 19, 2015, entitled “NOVEL COMPUTER IMPLEMENTED SYSTEMS AND METHODS FOR MEDICAL COMMUNICATION, MEDICAL RECORD KEEPING, AND DOCUMENTATION”, which is hereby incorporated by reference in its entirety.

### FIELD OF THE INVENTION

This patent specification relates to the field of medical communication, language translation, and medical record keeping and documentation. More specifically, this patent specification relates to computer implemented methods and systems for client devices to allow medical staff to communicate with patients in a variety of languages and to record and document the patient's response to questions and gather medical consent. This includes explanations and information given to patients.

### BACKGROUND

Doctors, clinics, and hospitals in the United States are responsible for treating the entire gamut of the community in which they operate. This obligates them to accepting patients who may not communicate well enough in English or other primary language of the medical staff to make their care appropriate and meaningful. Changing global demographics have resulted in cities with populations of peoples who have relocated and not adapted to the norms of the country where they reside or are visiting.

Typically, the disparity of language is often addressed by patients seeking treatment from healthcare providers in their own communities who spoke their language. This is not always possible and many patients find themselves under the care of a healthcare provider or being treated in a hospital where they cannot communicate with the doctors or other staff. This is not a new phenomenon especially in a country whose population is the result of successive large waves of immigrants from a wide range of countries.

What is new is a federal mandate that all patients be afforded care that they can understand and legally consent to. The responsibility for the translation falls on the healthcare provider, such as a doctor, nurse, nurse practitioner, and the like, in his office or on the hospital/clinic where the patient is seen and treated. Often patients arrive with a friend or relative who speaks both their language and English. Ancillary hospital personnel, housekeeping and dietary staff from the same immigrant communities as the patients, no longer meet legal guidelines to assist in translating for patients. Their translations have no official legal certification, and involving unofficial translators poses the risk of breaching of privacy provisions of the Health Insurance Portability and Accountability Act of 1996 (HIPAA).

When the use of certified independent interpreters is needed, the cost of their services is the responsibility of the healthcare provider's office or the hospital. This cost cannot be borne by or passed on to the patient or the medical insurance, including Medicare and Medicaid.

There is therefore a financial and ethical incentive for hospitals and healthcare providers to use novel computer implemented methods and systems to communicate with patients in different languages and to record important patient responses and information using electronic client devices.

### BRIEF SUMMARY OF THE INVENTION

A medical interaction system for providing cross-language communication between a first user and a second user is provided. In some embodiments, the system may include: a speaker for providing audio output to the users; a graphical user interface for displaying visual information output to and receiving user input from the users; and a processor in communication with the speaker and the graphical interface, in which the processor is configured to identify a first language selected by the first user with the graphical user interface, identify a second language selected by the second user with the graphical user interface, receive first language input from the first user, interpret the first language input into a second language output, provide the second language output to the second user, receive second language input from the second user, determine second user consent to the second language output, interpret the second language input into first language output, and provide the first language output to the first user.

According to another embodiment consistent with the principles of the invention, a medical interaction method for providing cross-language communication between a first user and a second user is provided. The method may include: identifying a first language selected by the first user; identifying a second language selected by the second user; receiving first language input from the first user; interpreting the first language input into a second language output; providing the second language output to the second user; receiving second language input from the second user; determining second user consent to the second language output; interpreting the second language input into first language output; and providing the first language output to the first user.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a medical interaction system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram illustrating some exemplary input/output interfaces of a client device which may be used by the system as described in various embodiments herein.

FIG. 5 illustrates a block diagram illustrating some modules of a medical interaction system which may function as software rules engines according to various embodiments described herein.

FIG. 6 shows a block diagram illustrating an example workflow of a medical interaction system according to various embodiments described herein.

FIG. 7 depicts a block diagram of an example of a method for providing medical interaction between two users according to various embodiments described herein.

FIG. 8 illustrates a block diagram of an example of an alternative method for providing medical interaction between two users according to various embodiments described herein.

FIG. 9 shows a screenshot of an example graphical user interface displayed on a client device of the system according to various embodiments described herein.

FIG. 10 depicts a screenshot of an example graphical user interface displayed on a client device of the system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### DEFINITIONS

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The term “client device” or sometimes “electronic device” or just “device” as used herein is a type of computer generally operated by a person. In some embodiments, a client device is a smart phone or computer configured to receive and transmit data to a server or other electronic device which may be operated locally or in the cloud. Non-limiting examples of client devices include; personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include; cell phones, smart phones, tablet computers, laptop computers, wearable computers such as watches, Google Glasses, etc. and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoW) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New medical interaction systems and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

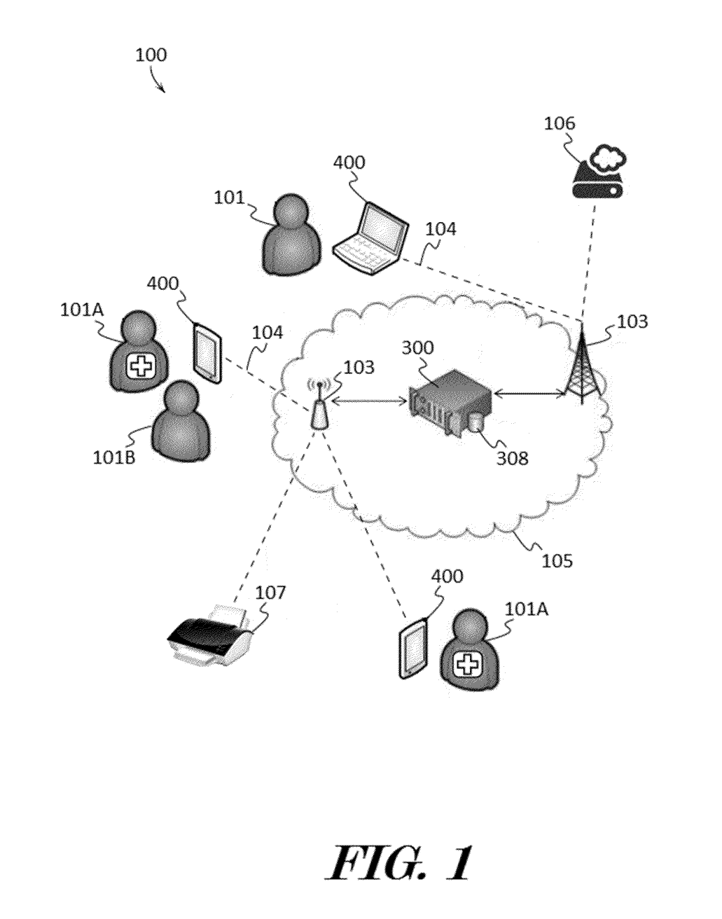

The present invention will now be described by example and through referencing the appended figures representing preferred and alternative embodiments. As perhaps best shown by FIG. 1, an illustrative example of some of the physical components which may comprise a medical interaction system (“the system”) 100 according to some embodiments is presented. The system 100 is configured to provide medical interaction, such as medical communication, medical record keeping, documentation, and the like, between users 101 that are proficient in different languages. Users 101 may include healthcare providers 101A, such as doctors, nurses, nurse practitioners, physicians assistants, dentists, and the like, and healthcare recipients 101B, such as patients, care receivers, patient representatives, and the like. The system 100 may also facilitate the transfer of data and information between one or more access points 103, client devices 400, printers 107, remote databases 106, and servers 300 over a data network 105. A data store 308 accessible by the server 300 may contain one or more databases. The data may comprise any information that one or more users 101 desire to input into the system 100 including information on one or more users 101, information requested by one or more users 101, information supplied by one or more users 101, and any other information which a user 101 may desire to input or enter into the system 100.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

In some embodiments, the data provided by a user 101, 101A, 101B, may comprise information to facilitate the medical care of one or more users 101B. This data may be referred to as medical history data which may be used to form an electronic health record which may be stored in a database on a data store 308 and/or printed as a hard copy by a printer 107. Additionally, medical history data of a user 101B may be stored on or retrieved from a remote database 106. For example, a third party remote database 106 may be accessed by the system 100 to retrieve blood work results or an X-ray image may be stored in a doctor's office remote database 106 which is physically remote from the location where the X-ray was taken.

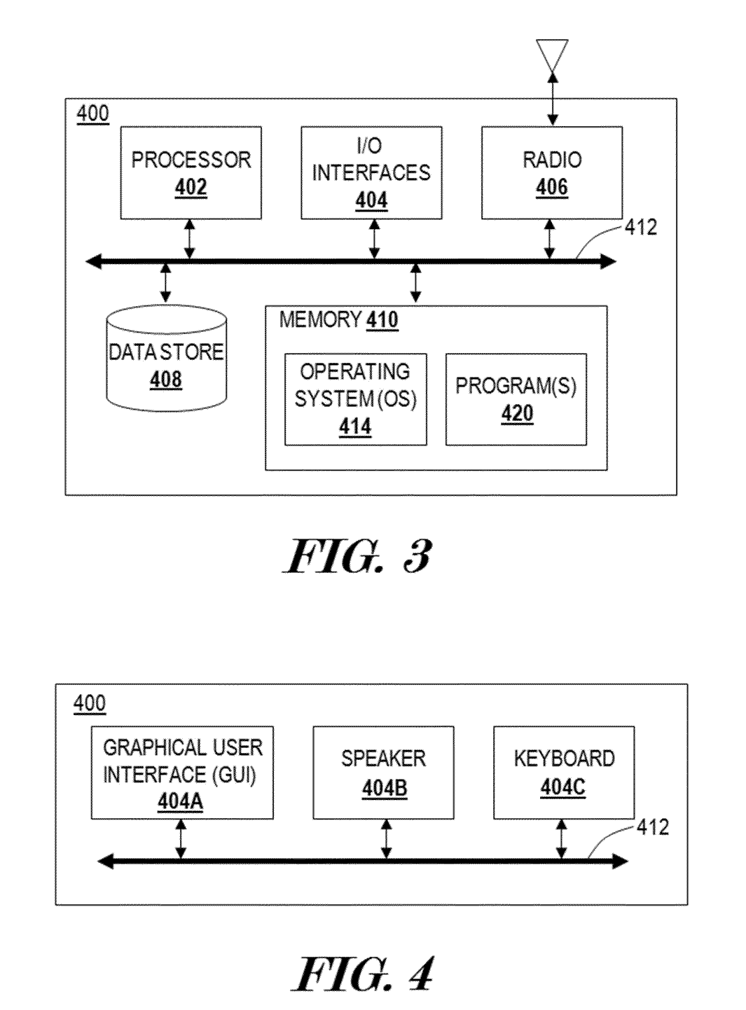

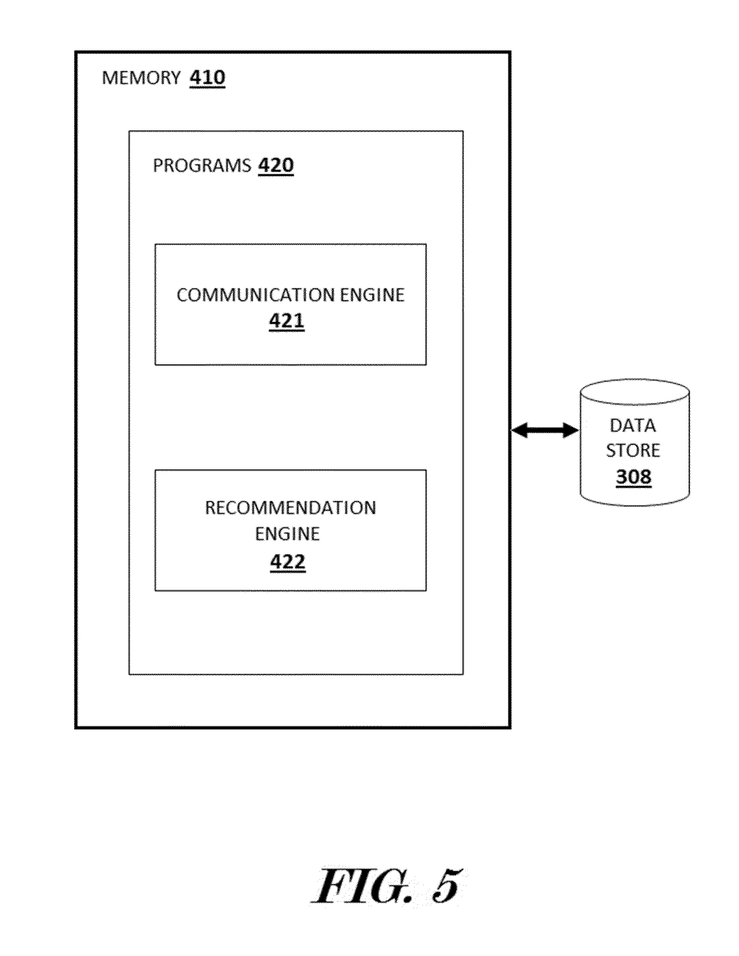

In some embodiments, the system 100 may comprise a client device 400 with input/output (I/O) interfaces 404 (FIG. 3) which may include a graphic user interface (GUI) 404A (FIGS. 4, 9, and 10) which may be operated by both a healthcare provider 101A and a healthcare recipient 101B. For example, the system 100 may be configured to be accessed by a client device 400, such as smartphone or tablet computer, with a GUI 404A which may be operated by both the healthcare provider 101A and the healthcare recipient 101B allowing them to communicate and build an electronic medical record which may be stored on a database 106 or a data store 38 or may be printed out on a printer 107.

In alternative embodiments, the system 100 may comprise two or more client devices 400, each with input/output (I/O) interfaces 404 (FIG. 3) which may include a (GUI) 404A (FIGS. 4, 9, and 10). A healthcare provider 101A may operate a GUI 404A of a first client device 400 and a healthcare recipient 101B may operate a GUI 404A of a second client device 400. For example, the system 100 may be configured to be accessed by a first client device 400, such as smartphone, with a first GUI 404A which may be operated by the healthcare provider 101A, and accessed by a second client device 400, such as computer, with a second GUI 404A which may be operated by the healthcare recipient 101B. The system 100 may allow the first client device 400 of the healthcare provider 101A and the second client device 400 of the healthcare recipient 101B to communicate, thereby allowing the healthcare provider 101A and the healthcare recipient 101B to build an electronic medical record which may be stored on a database 106 or a data store 38 or may be printed out on a printer 107.

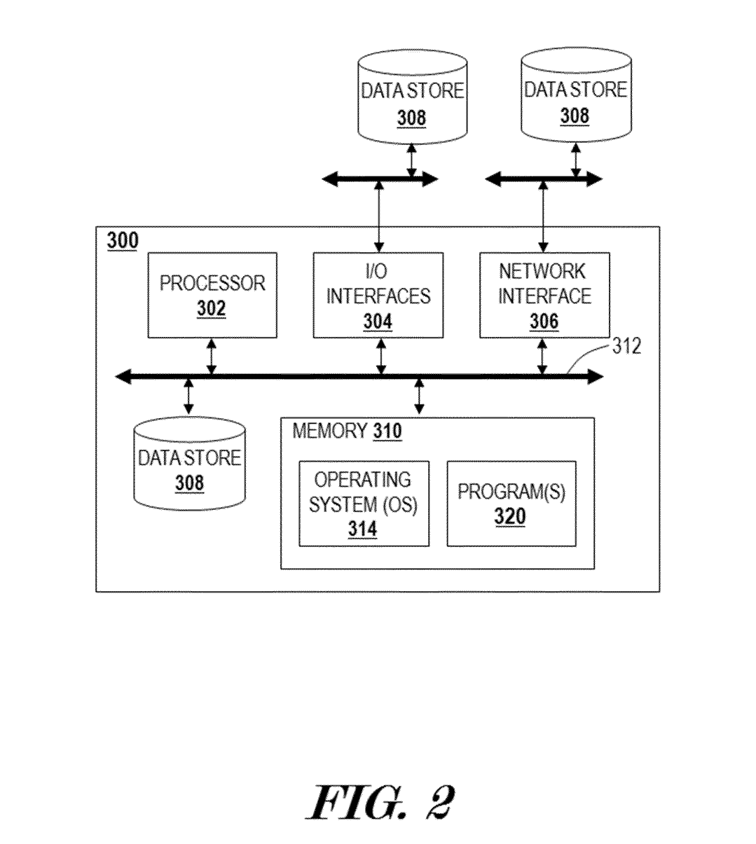

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a graphical user interface, a keyboard, a touch pad, and/or a mouse. System output may be provided via a display device, a graphical user interface, a speaker, and/or a printer 107 (FIG. 1). I/O interfaces 304 may further include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

Referring to FIG. 3, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications. The I/O interfaces 404 can be used to receive data and user input and/or for providing system output. User input can be provided via a plurality of I/O interfaces 404, such as a keypad, a graphical user interface 404A (FIG. 4), a speaker 404B (FIG. 4), a keyboard 404C (FIG. 4), a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Windows 7, Windows 8, Windows 10, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user 101 typically uses one or more of the programs 420, optionally along with a network, to perform one or more steps of a medical interaction method of the system 100.

FIG. 4 shows some example input/output interfaces 404 (FIG. 3) of a client device 400 according to various embodiments described herein. In some exemplary embodiments, a GUI 404A may comprise a resistive or capacitive touch screen. The GUI 404A may be in communication with the processor 402 (FIG. 3) through the local interface 412 (FIG. 3). Additionally, the GUI 404A may receive touch input from a user 101 (FIG. 1) and/or display visual information which may be communicated to and from the processor 402. In further embodiments, a GUI 404A may be configured with a variety of touch screen technologies that have different methods of sensing touch such as capacitive sensing, surface capacitive touch sensing, surface acoustic wave sensing, projected capacitance sensing, mutual capacitance sensing, self-capacitance sensing, infrared grid sensing, infrared acrylic projection sensing, optical imaging, dispersive signal sensing, acoustic pulse recognition sensing, or any other suitable tactile input that may detect touch input on a display device. A GUI 404A may also comprise a display device such as a Liquid Crystal Display (LCD), a Cathode ray tube (CRT) display, a Field emission display (FED), a Vacuum fluorescent display (VFD), a Surface-conduction electron-emitter display (SED), a thin or thick film electro-luminescence (EL) display, an inorganic or organic light emitting diode (LED, OLED) display, a Plasma display panel (PDP), a gas discharge display (Nixie tube), or any other suitable display for outputting visual information.

In some embodiments, a speaker 404B may comprise a sound device configured to produce or create one or more audible sounds at one or more volume levels. The speaker 404B may be in communication with the processor 402 (FIG. 3) through the local interface 412 (FIG. 3). Additionally, the speaker 404B may output audio information which may be communicated from the processor 402. In further embodiments, a speaker 404B may comprise a buzzer, a piezoelectric sound producing device, a dielectric elastomer sound producing device, a buzzer, a moving coil loudspeaker, an electrostatic loudspeaker, an isodynamic loudspeaker, a piezo-electric loudspeaker, or any other device capable of producing one or more sounds.

In some embodiments, a keyboard 404C may comprise QWERTY, numerical, or the like, keyed input device that may be manipulated by a user 101 (FIG. 1) to provide input to the system 100. The keyboard 404C may be in communication with the processor 402 (FIG. 3) through the local interface 412 (FIG. 3). Additionally, the keyboard 404C may receive information which may be communicated to the processor 402. A keyboard 404C may comprise any type of keyboard which may be used with an electronic device 400.

FIG. 5 depicts a block diagram showing some software rules engines which may be found in a system 100 (FIG. 1) and which may preferably be configured to run on a processor 402 of a client device 400 and/or optionally on a processor 302 of a server 300 (FIGS. 1 and 2) according to various embodiments described herein. In some embodiments, one or more client devices 400 may be configured to run one or more software rules engines or programs 420 such as a communication engine 421 and/or a recommendation engine 422. In this embodiment, the engines 421, 422, are configured to run on at least one client device 400. Additionally, a client device 400 may be in communication with a server 300 and data store 308 comprising a database of medical history data which may be used to form an electronic health record of one or more users 101 (FIG. 1). The engines 421, 422, may read, write, or otherwise access data in the database of the data store 308. Additionally, data may be sent and received to and from one or more client devices 400 (FIGS. 1 and 3) which may be in wired and/or wireless electronic communication with a server 300 through a network 105. In other embodiments, a communication engine 421 and/or a recommendation engine 422 may be configured to run on a client device 400 and/or server 300 with data transferred to and from one or more servers 300 in communication with a data store 308 through a network 105. In still further embodiments, a server 300 and a client device 400 may be configured to run a communication engine 421 and/or a recommendation engine 422.

The communication engine 421 may be configured to govern electronic communication between severs 300, third party databases, and client devices 400. Data from severs 300, third party databases 106, and client devices 400 may be received by the communication engine 421 which may then electronically communicate the data to the recommendation engine 422. Likewise, data from the recommendation engine 422 may be received by the communication engine 421 which may then electronically communicate the data to severs 300, third party databases 106, and client devices 400. In some embodiments, the communication engine 421 may govern the electronic communication by initiating, maintaining, reestablishing, and terminating electronic communication between the server 300 and one or more third party databases, client devices 400, and other servers 300. In further embodiments, the communication engine 421 may control the radio 406 or other network interface (FIG. 3) of a client device 400 to send and receive data to and from one or more third party databases 106, client devices 400, and other servers 300 through a network connection 104 (FIG. 1) over a network 105 (FIG. 1).

The communication engine 421 may be configured to receive language input from a user 101 through an I/O interface 404 of a client device 400 such as through a GUI 404A and/or a keyboard 404C. Optionally, the communication engine 421 may be configured to receive language input from a user 101 through an I/O interface 404 of a client device 400 which comprises a microphone. The communication engine 421 may also be configured to output or display images, graphics, videos, indicia, and other visual information as language output through a GUI 404A and/or to output sounds, audio recordings, and other audio information through a speaker 404B. In some embodiments, the communication engine 421 may be configured to output visual information through a GUI 404A and to output audio information through a speaker 404B in a first language selected by a first user 101A and in a second language selected by a second user 101B. In further embodiments, the communication engine 421 may be configured to output visual information through a GUI 404A and to output audio information through a speaker 404B in a plurality of language outputs which may be selected by one or more users 101.

In some embodiments, the communication engine 421 may govern the electronic communication between the server 300, data store 308, and/or a third party database 106 to allow medical history data on a patient to be stored in or retrieved from a data store 308, and/or a third party database 106. For example, the communication engine 421 may govern the electronic communication between the server 300 of the system 100 and a server 300 operated by a hospital or healthcare network thereby allowing medical history data to be sent to and retrieved from the a data store 308 and/or third party database 106 of the hospital or healthcare network.

In some embodiments, the communication engine 421 may be configured to interpret between a first language, a second language, a third language, and/or any other number of languages. A first language refers to any language which may be preferred or selected by a first user 101A, while a second language refers to any language which may be preferred or selected by a second user. Since they system 100 provides translation, it is desired that the first language is a different language than the second language. In further embodiments, the communication engine 421 may interpret between a first language and a second language by querying a database accessible to the system 100 for a second language output that may be associated with a first language input. For example, a healthcare provider 101A may select a first language of English and a healthcare recipient 101B may select a second language of Spanish. The healthcare provider 101A may select a first language input comprising a question in English about where the healthcare recipient 101B is feeling pain. The communication engine 421 may query a database, such as may be stored on a data store 308 (FIG. 2), data store 408 (FIG. 3), or a remote database 106 (FIG. 1), to return the same question or its equivalent in Spanish which may then comprise the second language output. In alternative embodiments, the communication engine 421 may interpret between a first language and a second language by using an on-the-fly translation engine such as Google Translate® or an equivalent.

In some embodiments, the communication engine 421 may be configured to identify language selections by a user 101. The communication engine 421 is further configured to communicate in multiple modalities. That is, the communication engine 421 may display prerecorded videos, audio, text, or images to the users 101 in a variety of languages. These video, audio, text, or images files may be stored on the client device 400 or on a remote computer such as a server 300 and accessed through a data network 105. The communication engine 421 is also configured to record user responses to questions (also called “user input data”). Some non-limiting ways the communication engine 421 may record patient input data are: (1) by recording a user's 101 touch on the GUI 404A of a client device 400 (e.g. a user 101 may touch a “YES” or “NO” button on the screen of the client device 400), (2) by recording a user's voice, (3) by capturing a user's signature or other input on the GUI 404A of the client device 400. The communication engine 421 may provide one or more language outputs as audio and/or visual information through a speaker 404B and/or a GUI 404A. The user may then select a desired language by providing input to a GUI 404A, keyboard 404C, or other I/O interface 404. The communication engine 421 may use the language selection input to identify a first language selected by a first user 101A, a second language selected by a second user 101B, a third language selected by a third user, and so on. Once a language is selected by the user 101, the communication engine 421 may use that language selection to send and receive language output and input to that user 101.

In some embodiments, the recommendation engine 422 may be configured to determine and/or to store user consent in a database, such as may be stored on a data store 308 (FIG. 2), data store 408 (FIG. 3), or a remote database 106 (FIG. 1). The recommendation engine 422 may be configured to provide language output on an I/O interface 404 to a user 101 in the form of a question that ascertains if the user 101 understands and/or consents to language output that was previously provided to the user 101. The user 101 may then provide language input, such as an affirmative input or a negative input, through the I/O interface 404 which may be communicated to the recommendation engine 422 and used to determine the understanding or consent to the language output. For example, a second user 101B may select a language of Hindi and be provided second language output comprising instructions for care of their medical condition in Hindi by the communication engine 421 through a speaker 404B and/or GUI 404A. The communication engine 421 may then provide second language output on a GUI 404A and/or speaker 404B comprising the question “Do you understand and consent to the treatment provided?” and the words “Yes” and “No” in Hindi. The second user 101B may then provide second language input by selecting “Yes” and “No” displayed on the GUI 404A in Hindi. If the second user 101B selects the affirmative “Yes”, the recommendation engine 422 may determine that the second user 101A does consent and/or understands the previous second language output comprising the instructions. If the second user 101B selects the negative “No”, the recommendation engine 422 may determine that the second user 101A does not consent and/or understand the previous second language output comprising the instructions. Once the recommendation engine 422 has determined the consent and/or understanding of the second user 101B, the consent information may be communicated to the communication engine 421 which may then store the consent information in a database, such as may be stored on a data store 308 (FIG. 2), data store 408 (FIG. 3), or a remote database 106 (FIG. 1).

In some embodiments, a recommendation engine 422 may be configured to provide recommendations based on input provided by a user 101 of the system 100. Input by a user 101 may comprise language input and/or language output received by an I/O interface 404 which may be received by the communication engine 421 and communicated to the recommendation engine 422. In further embodiments, the system 100 may include a plurality of pre-recorded video files, audio files, and text messages in multiple (at least 2) languages which may be stored in a database, such as a data store 308 (FIG. 2), data store 408 (FIG. 3), or a remote database 106 (FIG. 1) accessible to the system 100. Based on language input or output received from a user 101, the recommendation engine 422 may select or retrieve one or more pre-recorded video files, audio files, or text messages which may be used to form a recommendation to be output to a user 101 through an I/O interface 404. The spoken/video portions of the application will be recorded clearly in a standard format preferably by native speakers of each language and maintained in language sets on a database accessible to the system 100. For example, the communication engine 421 may be configured to display to a user 101 a video explaining the signs of a heart attack based on patient input data that indicates chest pain (e.g. a patient enters “yes” when asked about chest pain). The video in this example will be a prerecorded video in the patient's preferred language as determined by the system 100.

For example, the recommendation engine 422 may determine that immediate medical attention is necessary based on certain pre-defined criteria (e.g. a healthcare recipient 101B provides language input through a GUI 404A of the system 100 that they are having difficulty breathing). The recommendation engine 422 may then retrieve one or more recommendations from a database on a data store 308 (FIG. 2), data store 408 (FIG. 3), or a remote database 106 (FIG. 1) accessible to the system 100 such as; “seek immediate medical help”, or “display videos on choking” associated with the language input provided by the healthcare recipient 101B. The recommendations may then be communicated to the communication engine 421 which may then output the recommendations as video files, audio files, or text messages through a GUI 404A and/or speaker 404B.

In further embodiments, the recommendation engine 422 may be configured to provide recommendations based on medical history data of a healthcare recipient 101B that may be retrieved from a database on a data store 308 (FIG. 2), data store 408 (FIG. 3), or a remote database 106 (FIG. 1) accessible to the system 100. The recommendation engine 422 may direct the communication engine 421 to retrieve or access data from the database and to output the recommendation through an I/O interface. For example, if a healthcare recipient 101B provides language input or output data that relates to a high body temperature and the feeling of chills through a GUI 404A, the communication engine 421 may communicate the data to the recommendation engine 422 which may direct the communication engine 42 to retrieve a language output from a database that instructs the patient 101B to drink fluids and to avoid taking a cold medication that may interfere with a blood pressure medication that the healthcare recipient 101B is currently taking as recorded in the healthcare recipient's 101B medical history data in the database. This recommendation may then be output as a video file, audio file, or text message by the communication engine 421 through a GUI 404A and/or speaker 404B.

In some embodiments, medical history data may include any data that may be descriptive of a user 101, such as a healthcare provider 101A or a healthcare recipient 101B, which may be stored in a database on a data store 308 (FIG. 2), data store 408 (FIG. 3), or a remote database 106 (FIG. 1) accessible to the system 100. The data may include, but is not limited to: the chief complaint, including the location, duration, description of symptoms, chronologic course of the complaint, treatments to date; Surgical History, types and descriptions of surgeries and dates; Medical History including but not limited to medication taken currently and in the past, allergies, smoking history, alcohol history, non-prescription drug or recreational drug history, cancer, and stroke; Review of Systems: General/Constitutional including but not limited to average weight, weight loss or gain, general state of health, sense of well-being, strength, ability to conduct usual activities, exercise tolerance; Skin/Breast including but not limited to rash, itching, pigmentation moisture or dryness, texture, changes in hair growth or loss, nail changes, bruising, birthmarks, moles, ulcers, decubiti, sun exposure and protection, breast lumps, tenderness, swelling, nipple discharge; Eyes/Ears/Nose/Mouth/Throat including but not limited to headaches (location, time of onset, duration, precipitating factors), vertigo, lightheadedness, injury; change in vision, double vision, tearing, blind spots, pain, inflammation, infections, scotomata, ptosis, nose bleeding, colds, obstruction, discharge, epistaxis, sinus pain, dental difficulties, gingival bleeding, dentures, tinnitus, change in hearing, running or discharge from the ears, deafness, dizziness, mouth and throat hoarseness, dysphagia, bleeding gums, sore throat, ulcers or sores in the mouth, neck stiffness, pain, tenderness, masses in thyroid or other areas; Cardiovascular System including but not limited to chest pain, precordial pain, sub sternal distress, syncope, dyspnea, palpitations, weakness, intolerance of exercise, varicosities, swelling of extremities, known murmur, hypertension, asystole, orthopnea, nocturnal paroxysmal dyspnea, edema, cyanosis, hypertension, varicosities, phlebitis, claudication; respiratory tract including but not limited to cough (time of day), sputum (amount in tablespoons or cups per day and color), change in sputum, night sweats, nocturnal dyspnea, wheezing, pain (location, quality, relation to respiration), shortness of breath, stridor, hemoptysis, respiratory infections, tuberculosis or exposure to it, fever; Gastrointestinal System including but not limited to nausea, vomiting, diarrhea, constipation, quality of appetite, change in appetite, dysphagia, gas, heartburn, melena, change in bowel habits, use of laxatives or other drugs to alter the function of the gastrointestinal tract, food idiosyncrasies, abdominal pain, eructation, hematemesis, jaundice, constipation, hemorrhoids, abnormal stools (clay-colored, tarry, bloody, greasy, foul smelling); Genitourinary System including but not limited to urinary tract: dysuria, change in color of urine, change in frequency of urination, pain with urgency, incontinence, edema, retention, urgency, nocturia, hematuria, polyuria, oliguria, change in color or urine, stones, infections, nephritis, hesitancy, change in size of stream, dribbling, libido, genital tract (female) menstrual history (onset of menses, regularity, last period, dysmenorrhea, menorrhagia, metrorrhagia), post-menopausal bleeding, dyspareunia, obstetric history (number and results of pregnancies-gravida/para), contraceptive use, discharge, pain or discomfort, pruritus, history of venereal disease, sexual history; genital tract (male) penile discharge, pain or discomfort, pruritus, skin lesions, hematuria, history of venereal disease, sexual history; Musculoskeletal System including but not limited to heat; redness; swelling; limitation of motion; deformity; crepitation: pain in a joint or an extremity, the neck, or the back, especially with movement, muscular weakness, atrophy, cramps; Neurologic/Psychiatric Systems including but not limited to nervous system: Paralyses, incoordination, dizziness, tremor, ataxia, difficulty in speaking, change in speech, paresthesia, loss of sensation, seizures, syncope, changes in memory; Psychologic status including but not limited to predominant mood (nervousness, depression, hallucinations) nervousness, instability, depression, phobia, sexual disturbances, criminal behavior, insomnia, night terrors, mania, memory loss, perseveration, disorientation, previous psychiatric care; Allergic/Immunologic/Lymphatic/Endrocrine Systems including but not limited to reactions to drugs, food, insects, skin rashes, trouble breathing, hematopoietic spontaneous or excessive bleeding, fatigue, enlarged or tender lymph nodes, pallor, history of anemia, transfusions, Rh incompatibility, asthenia, endocrine system tremor, palpitations, intolerance of heat or cold, polyuria, polydipsia, polyphagia, diaphoresis, exophthalmos, goiter, hormone therapy, growth, secondary sexual development. Optionally, the data can then be printed and made part of the patient's legal medical record after being confirmed accurate by the healthcare provider 101A and/or healthcare recipient 101B.

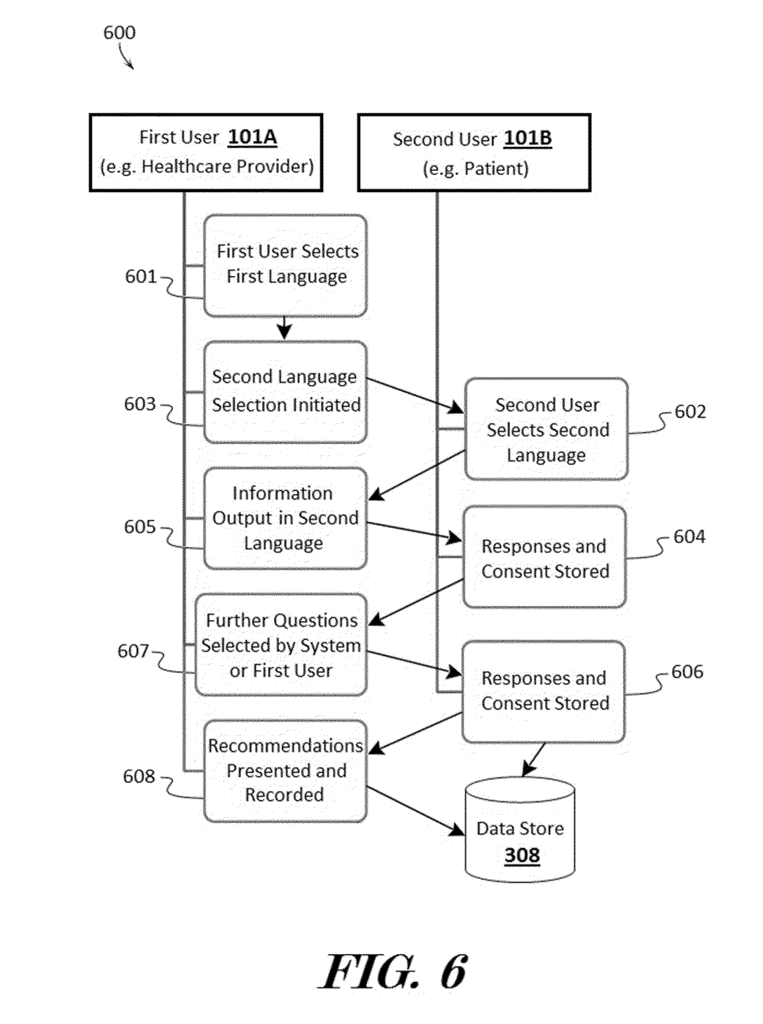

FIG. 6 shows a block diagram illustrating an example workflow 600 of a medical interaction system 100 (FIG. 1) according to various embodiments described herein. In this example workflow 600 the first user 101 (FIG. 1) may comprise a healthcare provider 101A, such as a doctor, and the second user 101 may comprise a healthcare recipient 101B such as a patient. The workflow 600 may be performed with a client device 400 (FIGS. 1, 3, and 4) which may comprise a GUI 404A (FIG. 4) and a speaker 404B (FIG. 4). In this example, the first user 101A may select their preferred or first language using the GUI 404A in step 601. Next, the system 100 may initiate the selection of the second language or preferred language of the second user 101B in step 602. The second user 101B may select their second language using the GUI 404A of the electronic device 400 in step 603. The first user 101A may input information in a first language that may be interpreted by the system 100 and the information may be output in the second language, such as in with text, audio, and/or video in the second language in step 604. The second user 101B may input responses and consent information in the second language through the GUI 404A or other I/O interface 404 which may be stored in a database such as on a data store 308 accessible to the system 100 in step 605. In some preferred embodiments, selections and responses entered by the first 101A and/or second 101B user may trigger an audible confirmation. For example, when a Spanish speaking second 101B touches the “si” or “no” button or icon on a GUI 404A of the electronic device 400 in response to a yes/no question, the device 400 may audibly output the word “si” or “no” so that the second 101B has audible confirmation that the intended response was given. Further questions may be selected by the system 100, such as by the recommendation engine 422, on by the first user 101A forming first language input which may be interpreted and output as second language output in step 606. The scope of the questions may include, but is not limited to, the complete review of systems, explanation of procedures, informed consent, discharge instructions, and/or any other medically or legally relevant information. In fact, this same format can be used for pre-translated standardized communication in fields other than medicine.

The second user 101B may input responses and consent information in the second language through the GUI 404A or other I/O interface 404 which may be stored in a database such as on a data store 308 accessible to the system 100 in step 607. Based on the responses and consent, the recommendation engine 422 may communicate one or more recommendations to the communication engine 421 which may be displayed or output to the second user 101B and recorded in the database. The first 101A and second 101B users may continue to operate the client device according to this workflow until desired. In some embodiments, the questions and responses of the first 101A and second 101B users may be printed or exported in both the interviewer's, or first user's 101A, first language and the patient's, or second users' 101B, second language for verification and confirmation. In further embodiments, a bilingual copy of the questions and responses of the first 101A and second 101B users may be printed, provided through electronic message, or otherwise available for the patient or second user 101B which may be authenticated and signed by the patient 101B to indicate that the responses are correct preferably for legal purposes and implications.

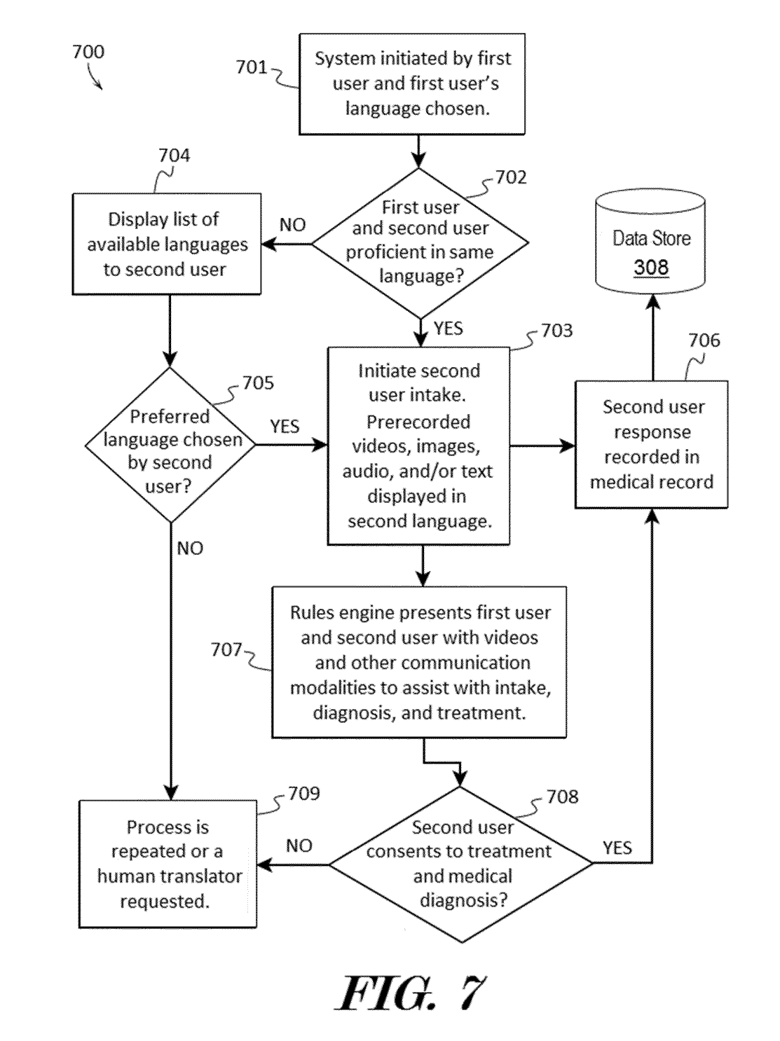

FIG. 7 depicts a block diagram of an example of a method for providing medical interaction (“the method”) 700 between two users, such as a healthcare provider 101A (FIG. 1) and a healthcare recipient 101B (FIG. 1), according to various embodiments described herein. In some embodiments of the method 700, the first user or healthcare provider 101A may first choose his preferred or first language on a client device 400 and the system 100 will record this selection and communicate (e.g. with text, with audio messages, and/or with video messages) with the first user in that first language in step 701. At step 702, if the first 101A and second 101B user are proficient in the same language, the method 700 may continue to step 703 in which the second user 101B intake may be initiated and prerecorded videos, images, audio, and/or text may be displayed in the second language on the client device 400. In some embodiments, a full question set, or a portion thereof chosen by a particular clinic for its specific intake form, may be loaded on a client device 400 such as an iPad. The second user 101B intake performed in step 703 may include the showing or streaming of video questions to the second user 101B and would allow the second user 101B to provide input with the client device 400 to answer the questions chosen for intake of the second user 101B.

If the first 101A and second 101B users are not proficient in the same language, the method 700 may continue to step 704 in which a list of available languages may be displayed on the client device 400 to the second user 101B. In this example, the first user 101A will then hand the client device 400 to the second user or healthcare recipient 101B and the system 100 will display a choice of available languages to the second user 101B. In step 705, if a preferred or second language is chosen by the second user 101B, the system 100 will then record the preferred or second language of the second user and communicate (e.g. with text, with audio message, and/or with video message) with the second user in that chosen second language in step 703. If the second user 101B does not choose a preferred or second language in step 705, the method may continue to step 709.

After the second user 101B intake is initiated in step 703, optionally the second user 101B responses may be recorded in the medical record or medical history data of the second user 101B in step 706 and stored in a data base in a data store 308, data store 408 (FIG. 3), or remote database 106 (FIG. 1). In some embodiments, the second user 101B responses may be printed out or ported to an electronic medical record and not stored in the client device 400 or the server 300. In further embodiments, no second user 101B identification data may be stored by the client device 400 to avoid HIPPA concerns. Optionally, after step 703, the method 700 may continue to step 707 in which a rules engine, such as the communication engine 421 (FIG. 5), presents the first user 101A and second user 101B with videos and other communication modalities to assist with intake, diagnosis, and treatment. Next in step 708, the recommendation engine 422 (FIG. 5) may determine consent of the second user 101B to treatment and/or medical diagnosis. If the second user 101B does not consent, the method 700 may continue to step 709 in which the process 700 may be repeated or a human translator may be requested. If the second user 101B does consent, the method 700 may continue to step 706 and the consent may be stored in a database in a data store 308, data store 408, or remote database 106.

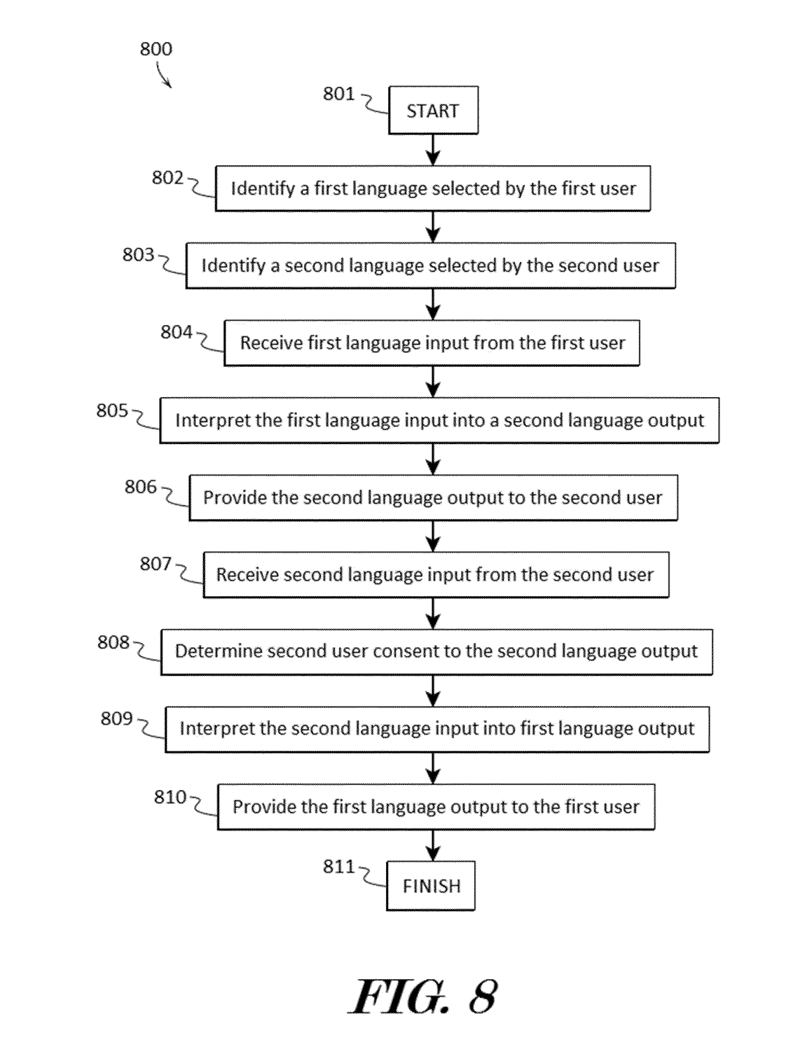

FIG. 8 illustrates a block diagram of an example of an alternative method for providing medical interaction between two users (“the method”) 800 according to various embodiments described herein. In some embodiments, the method 800 may start 801 and a first language selected by the first user 101A (FIG. 1) may be identified in step 802. The first language may be identified by the communication engine 421 through input provided by the first user 101A through an I/O interface 404 (FIG. 3), such as a GUI 404A (FIG. 4), keyboard 404C (FIG. 4), microphone, and the like, of a client device 400 (FIGS. 1, 3, and 4). For example, one or more languages may be displayed on the screen of a GUI 404A and the first user 101A may touch the screen to select the first language.

In step 803, a second language selected by the second user 101B (FIG. 1) may be identified. The second language may be identified by the communication engine 421 through input provided by the second user 101B through an I/O interface 404, such as a GUI 404A, keyboard 404C, microphone, and the like, of a client device 400. For example, one or more languages may be displayed on the screen of a GUI 404A and the second user 101B may touch the screen to select the second language.

Next, first language input from the first user 101A may be received by the communication engine 421 in step 804. The first language input may comprise questions, direction, or other information in the first language which the first user 101A desires to communicate to the second user 101B. For example, the first user 101A may speak or type into an I/O interface 404 of the client device 400 and the information may be communicated to the communication engine 421.

In step 805, the first language input may be interpreted into a second language output. The communication engine 421 may interpret the first language input provided by the first user into second language output which may be comprise audio and/or video of an individual conveying the interpreted information in the second language.

The second language output may then be provided to the second user 101B through the client device 400 in step 806. The communication engine 421 may output the second language output through an I/O interface 404, such as a speaker 404B and/or GUI 404A. For example, the communication engine 421 may direct the client device 400 to produce the second language output as a video or sound clip for the second user 101B in the second language.

In step 807, second language input from the second user 101B may be received by the communication engine 421. The second language input may comprise questions, answers, or other information in the second language which the second user 101B desires to communicate to the first user 101A. For example, the second user 101B may speak or type into an I/O interface 404 of the client device 400 and the information may be communicated to the communication engine 421.

Next in step 808, second user 101B consent to the second language output may be determined by the recommendation engine 422. The recommendation engine 422 may be configured to provide language output on an I/O interface 404 to a second user 101B in the form of a question that ascertains if the second user 101B understands and/or consents to language output that was previously provided to the second user 101B. The second user 101B may then provide language input, such as an affirmative input or a negative input, through the I/O interface 404 which may be communicated to the recommendation engine 422 and used to determine the understanding or consent to the language output of the second user 101B. In further embodiments, the recommendation engine 422 may store second user 101B consent in a database, such as may be stored on a data store 308 (FIG. 2), data store 408 (FIG. 3), or a remote database 106 (FIG. 1).

In step 809, the second language input may be interpreted into first language output. The second language input may be communicated from an I/O interface 404 to the communication engine 421 which may interpret the second language input into first language output. The first language output may comprise audio and/or video of an individual conveying the interpreted information in the first language.

The first language output may then be provided to the first user 101A through the client device 400 in step 810. The communication engine 421 may output the first language output through an I/O interface 404, such as a speaker 404B and/or GUI 404A. For example, the communication engine 421 may direct the client device 400 to produce the first language output as a video or sound clip for the first user 101A in the first language. Once the desired information has been exchanged between the first 101A and second 101B users, the method 800 may finish 811.

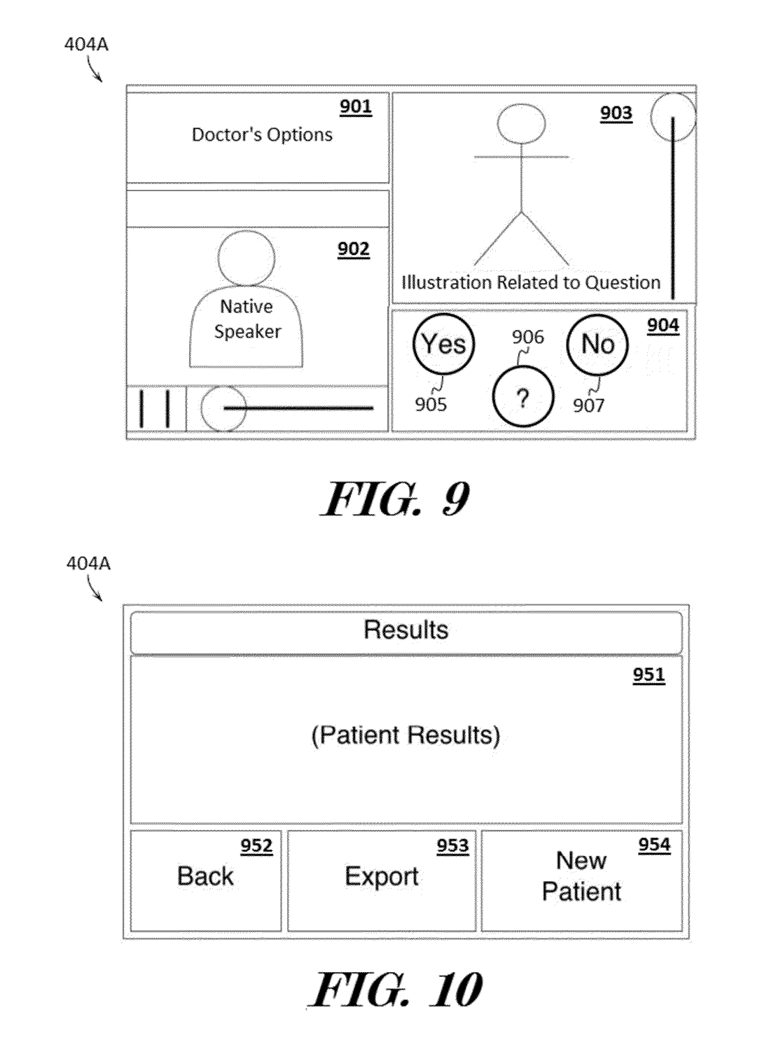

FIGS. 9 and 10 show examples of screenshots of a graphical user interface (GUI) 404A displayed on the screen of a client device 400 of the system 100 according to various embodiments described herein. The screenshots of FIGS. 9 and 10 are exemplary in nature as different arrangements, visual layouts, and styles of graphical user interfaces (GUI) 404A may be displayed by the system 100. In the following non-limiting example, a GUI 404A may be used by the system 100 (FIG. 1) to provide medical interaction between two or more users 101 (FIG. 1). In some embodiments, the system 100 may display a video clip to a second user or healthcare recipient 101B in the video window 902 (FIG. 9) of the GUI 404A. The video clip may be stored locally on the data store 408 (FIG. 3) of the client device 400 (FIGS. 1, 3, and 4) or on a data store 308 (FIGS. 1 and 2) of a server 300 (FIGS. 1 and 2) and accessed by the client device 400 through a data network 105 (FIG. 1). Each video clip may ask the second user 101B for a response. In preferred embodiments, the content of the video presented may be pre-translated by medically trained, certified medical translators where such certification exists, and reviewed for medical-legal accuracy. Optionally, the name of the language that the system is outputting may be displayed as titling in the videos themselves or elsewhere on the GUI 404A screen, or both. For example, if the first language comprises Italian and the second language comprises French, the system 100 a question input in Italian by a first user 101A may be output in French with possible answers to the question also output in French and optionally the name of the first and/or second language may also be displayed as titling proximate to the respective first and/or second language displayed on the GUI 404A.

The second user 101B may see the questions and information written in his selected second language in the text and illustration window 903 (FIG. 9) of the GUI 404A as well as hear it spoken to him by a native speaker of his language through a speaker 404B (FIG. 4) who may visually appear in a video window 902 on the screen of the GUI 404A speaking the question or information. The second user 101B may interrupt at any point and indicate if he needs further clarification or repetition, such as by touching a question icon 906 (FIG. 9) which may be displayed in the input window 904 (FIG. 9) of a touch screen GUI 404A. By interacting with a question icon 906 which preferably may be displayed on each screen of the GUI 404A on the client device 400, the second user 101B may be provided an audible and/or visual explanation of a question. This is particularly useful in cases in which the second user 101B may be unfamiliar with presented medical terminology.

The second user 101B may provide second language input comprising responses which may include yes, no, a number, multiple choice or other simple single entry responses which will be indicated by the patient by touching an appropriate screen icon, such as an affirmative icon 905 (FIG. 9), question icon 906 (FIG. 9), negative icon 907 (FIG. 9), explained to the second user 101B at the outset or at the time of the question.

The system may present a series of icons 905, 906, 907, in an input window 904 or other text or images onto a text and illustration window 903 of the GUI 404A interface on the client device 400. Such icons may include but are not limited to: an affirmative icon 906 optionally comprising a green circle with the word “yes” in the second user's 101B selected second language; a negative icon 907 optionally comprising a red circle with the word “no” in the second user's 101B selected second language; a question icon 907 optionally comprising a yellow circle with a question mark for the second user 101B to request clarification, one or more large numbered circles, several buttons or icons with choices included in the verbal question. These may be shape, color and word coded for clarity. Illustrations of the human body or parts thereof may be displayed for the users 101 to indicate the location of a symptom in a text and illustration window 903 on the GUI 404A. Therefore, the system 100 may be configured to accept and record a second user's 101B touch on a touch screen GUI 404A of a client device 404 to indicate a symptom or area of concern.

A confirmation button similar in function to “enter” to accept the response or indicate comprehension of the information provided which the second user 101B will be asked to touch at regular intervals during the interaction to confirm comprehension, consent, comfort, and to continue. Once the response is given, which may form second language input, by the second user 101B touching the appropriate screen icon or button, the first user 101A may touch a “next question” button or icon displayed in the first user's 101A or doctor's options window 901 (FIG. 9) to display a subsequent question or clip. The first user 101A may have several other buttons to use at his discretion ask the patient, such as button's or icons in a first language which may be used to provide second language output including but not limited to: Is everything clear so far?; Do you have any questions or concerns at this point?; Is the language you are hearing completely clear and understandable to you?; Do you need to take a break to go to the bathroom or have a cup of water?; and Would you like me to repeat the question? In this manner, the communication engine 421 may operate the processor 402 (FIG. 3) to output first language input, second language output, and second language input on the screen of the GUI 404A simultaneously.

As an initial intent of the system is to establish rapport between the first user 101A or doctor and second user 101B or patient while eliciting information from the patient about his medical history. Optionally, the users 101A, 101B may take turns tapping a screen button in their respective areas of the screen on a single client device 400 to create a fun game-like quality to the interaction.

The results of the first 101A and second 101B user interaction may be collected in a standardized organized format conforming to medical standard and legal standard. The standard medical record is necessary for proper documentation of the patient data upon which diagnostic tests such as xrays, laboratory studies, MRI, etc are based. It is also the body of information which the physical examination should confirm. It is important also because payment by insurance companies and government agencies such as Medicare is predicated on the completeness of the medical record. Therefore, the system 100 is configured to record the second user 101B responses and interaction using the client device 400. The response data (e.g. yes, no, I agree, I don't agree, etc.) may then be stored in a database, such as may be stored on a data store 308 (FIG. 2), data store 408 (FIG. 3), or a remote database 106 (FIG. 1). Optionally, the database may be located on a server 300 and thus the response data is transmitted to the server 300 from the client device 400 through a data network 105.

The first user 101A of the system 100 will have available all of the standard elements of the medical history data, plus additional options to include but not limited to explanations of proposed or recommended treatments, informed consents, and instructions to the second user 101B. The first user 101A may elect to present all of the questions in the set to a second user 101B or select a subset of these questions. Additionally, the system 100 may elicit from the first user 101A questions or instructions which he would like added to the available set, as well as additional languages he would like to be offered. Communication with a server 300 and data store 308 allows for these additional question and language options to be added in its continual maintenance and updates and may allow for a first user 101A to directly add content to the database in the form of original recorded audio and/or video questions. These may be identified by the contributor to be either for the contributor's own use or made available to all users 101. In further embodiments, a user 101A to user 101B communication feature may also be provided via online connection to allow a first 101A and second 101B user which are remote from each other to communicate through two different client devices 400. In still further embodiments, the system 100 may collect information from a second user 101B by recoding the second user's 101B actions such as touching the touch screen GUI 404A of a client device 400 or verbally interacting with the client device 400.

After the first user 101A has finished interviewing the second user 101B, the results page may be displayed on the GUI 404A of the client device 400. A non-limiting example of a screen which may be used is shown by FIG. 10. The back icon 952 ensures that if a mistake was made, it can be corrected. The export icon 953 may bring up options prompting the first user 101A to send the results to a printer 107 and/or save the results, which may be displayed in the patient results window 951, to a database such as may be stored on a data store 308 (FIG. 2), data store 408 (FIG. 3), or a remote database 106 (FIG. 1). Finally, the first user 101A can save the data and start with a new patient by touching the new patient icon 954.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A medical interaction system for providing cross-language communication between a first user and a second user, the system comprising:
a speaker for providing audio output to the users;
a graphical user interface for displaying visual information output to and receiving user input from the users; and
a processor in communication with the speaker and the graphical interface, wherein the processor is configured to
i. identify a first language selected by the first user with the graphical user interface,
ii. identify a second language selected by the second user with the graphical user interface,
iii. receive first language input from the first user,
iv. interpret the first language input into a second language output,
v. provide the second language output to the second user,
vi. receive second language input from the second user,
vii. determine second user consent to the second language output,
viii. interpret the second language input into first language output, and
ix. provide the first language output to the first user.

2. The system of claim 1, wherein the processor is in communication with a data store, and wherein the second user consent is stored in the data store.

3. The system of claim 2, wherein the second user consent stored in the data store comprises legal informed consent data.

4. The system of claim 1, wherein the second language output provided to the second user comprises an audio recording.

5. The system of claim 1, wherein the processor is configured to provide second language output recommendations based on second language input received from the second user.

6. The system of claim 1, wherein the processor is configured to output a query to the second user in the second language based on second language input received from the second user.

7. The system of claim 1, wherein the processor is configured to output a question in the first language which when selected by the first user forms the first language input from the first user.

8. The system of claim 1, wherein the processor is in communication with a data store comprising medical history data of the second user, and wherein the processor is configured to output a query to the second user in the second language based on the medical history data of the second user.

9. The system of claim 1, wherein the processor is configured to output first language input, second language output, and second language input on the graphical user interface simultaneously.

10. The system of claim 1, further comprising a first graphical user interface and a second graphical user interface, wherein the processor is configured to output first language input and first language output on the first graphical user interface, and wherein the processor is configured to output second language input and second language output on the second graphical user interface.

11. A medical interaction method for providing cross-language communication between a first user and a second user, the method comprising:
identifying a first language selected by the first user;
identifying a second language selected by the second user;
receiving first language input from the first user;
interpreting the first language input into a second language output;
providing the second language output to the second user;
receiving second language input from the second user;
determining second user consent to the second language output;
interpreting the second language input into first language output; and
providing the first language output to the first user.

12. The method of claim 11, further comprising storing the consent in a data store.

13. The method of claim 12, wherein the second user consent stored in the data store comprises legal informed consent data.

14. The method of claim 11, wherein the second language output provided to the second user comprises an audio recording.

15. The method of claim 11, wherein second language output recommendations are provided based on second language input received from the second user.

16. The method of claim 11, wherein a query is provided to the second user in the second language based on second language input received from the second user.

17. The method of claim 11, wherein the first user is presented with a question in the first language which when selected by the first user forms the first language input from the first user.

18. The method of claim 11, wherein medical history data of the second user is retrieved from a data store, and wherein the second user is queried in the second language based on the medical history data of the second user.

19. The method of claim 11, wherein the output first language input, second language output, and second language input are displayed on a graphical user interface simultaneously.

20. The method of claim 11, wherein the first language input and first language output are displayed on a first graphical user interface, and wherein the second language input and second language output are displayed on a second graphical user interface.
